(19) United States
(12) Patent Application Publication
(10) Pub. No.: US 2025/0341053 A1
(43) Pub. Date: Nov. 6, 2025

(54) METHOD FOR PRODUCING PULP SOFTENERS USING WASTE COOKING OIL

(71) Applicant: Chengdu Huadian Rongyu Biotechnology Co., Ltd, Chengdu (CN)

(72) Inventors: Heyun Lan, Meishan (CN); Kaiyuan Yu, Chengdu (CN); Hongxin Shen, Dazhou (CN)

(21) Appl. No.: 18/755,547

(22) Filed: Jun. 26, 2024

(30) Foreign Application Priority Data
May 6, 2024 (CN) 202410544487.3

(51) Int. Cl. D21C 3/02; C11B 13/00; D21C 3/00

(52) U.S. Cl. CPC D21C 3/02; C11B 13/00; D21C 3/003

(57) ABSTRACT

Disclosed is a method for producing pulp softeners using waste cooking oil. Using waste cooking oil to produce pulp softeners through steps 1 to 5 can not only reduce the process and cost of resource utilization of waste cooking oil, but also reduce the emission of pollutants, which is in line with the concept of environmental protection, and raw materials used in the production process are all renewable resources and are sustainable. The production process is simple and fast, and key technical parameters for each step are set optimally to ensure a smooth treatment process, improving the preparation efficiency and quality stability of a product.

### CROSS-REFERENCE TO RELATED APPLICATIONS

This application claims priority of Chinese Patent Application No. 202410544487. 3, filed on May 6, 2024, the entire contents of which are incorporated herein by reference.

### TECHNICAL FIELD

The present disclosure relates to the technical field of pulp softener production, and specifically to a method for producing pulp softeners using waste cooking oil.

### BACKGROUND

The current resource utilization of waste cooking oil is realized mainly through processes such as heating, filtration and adsorption to convert waste oil into biodiesel, lubricating oil, release agents and other products. However, there are many problems in the existing process, including complex production processes, high production costs, low output rates, the generation of solid waste and solid pollutants, etc. On the other hand, during the production of pulp, a large number of caustic soda is widely used to soften raw materials for pulp, leading to high production costs, the discharge of large amounts of waste water, environmental pollution, etc. Currently, about one hundred and thirty kilograms of caustic soda are used to produce one ton of pulp, and during washing, four hundred tons of waste water are generated in the production of one ton of pulp, leading to environmental pollution. As a result, pulp production enterprises face the challenge of dealing with the problems of waste water and caustic soda, and accordingly, the production cost rises constantly. These problems bring about the low efficiency of existing production process, and surreptitious discharge, exacerbating the environmental pollution potential, and new solutions are required for improving production efficiency and reducing production costs and environmental pollution. Accordingly, the development of a new type of waste cooking oil resource utilization technology, and research and development of pulp softeners capable of substituting caustic soda to promote the implementation of the concept of sustainable development will become the key to solving the current problems.

The existing method for producing pulp softeners using waste cooking oil involves a plurality of complex processes, which require much time and more manpower resources, and the failure to optimally set key technical parameters results in unstable production quality of the pulp softeners, with large batch-to-batch variations. Therefore, there is a need to provide a method for producing pulp softeners using waste cooking oil to solve the above technical problems.

### SUMMARY

In response to the deficiencies of the prior art, the present disclosure provides a method for producing pulp softeners using waste cooking oil to solve the problems that a plurality of complex processes are involved, which require much time and more manpower resources, and the failure to optimally set key technical parameters results in unstable production quality of the pulp softeners, with large batch-to-batch variations.

To realize the above objective, the present disclosure provides the following technical solutions: a method for producing pulp softeners using waste cooking oil includes the following steps:
step 1, preparation: collecting waste cooking oil, heating the same until it is completely melted into a liquid state, preparing a filter mesh for filtering out solid matter from the waste cooking oil, and preparing an oil-water separator for separating water from the waste cooking oil;
step 2, preliminary treatment: filtering out the solid matter from the liquid waste cooking oil through the filter mesh to obtain preliminarily purified waste cooking oil;
step 3, oil-water separation: separating water from the preliminarily purified waste cooking oil using the oil-water separator, ensuring that the waste cooking oil is dry and pure, to obtain purified waste cooking oil;
step 4, pulp softener preparation: performing preparation according to a ratio of 50% of water: 50% of the purified waste cooking oil: 3% of caustic soda; and
step 5, production of a ton of pulp softeners: putting 500 kg of tap water into a heatable stirring tank together with 500 kg of the purified waste cooking oil, followed by heating to 90° C. with continuous stirring, adding 30 kg of the caustic soda in the process of the heating, performing continuous stirring for 2 h-3 h after the caustic soda is completely added, slowly stopping the stirring when yellow paste-like matter is formed on a side of the stirring tank in the process of the continuous stirring, and stopping the stirring until a large amount of the yellow paste-like matter is formed, followed by standing for cooling to obtain pulp softeners.

Further, in step 1, the filter mesh has a pore diameter of 1 mm.

Further, in step 2, the filter screen is regularly cleaned to avoid clogging, ensuring that the waste cooking oil is capable of fully passing through the filter mesh and separating the solid matter thoroughly.

Further, in step 3, in the process of water separation, a time of the separation is controlled between 20 min-30 min, and a temperature of the separation is controlled between 40° C.-60° C.

Further, in step 3, dryness of the purified waste cooking oil is verified to ensure that water content in the purified waste cooking oil is between 2%-5%.

Further, in step 5, in the process of adding the caustic soda, the caustic soda is added slowly and evenly with continuous stirring to ensure that the caustic soda is fully dissolved and mixed.

Further, in step 5, in the process of the continuous stirring for 2 h-3 h, a stirring intensity is controlled at a moderate level, neither too intense nor too gentle, and a stirring frequency is controlled at a moderate level, neither too fast nor too slow, to ensure that reactants are fully mixed.

Further, in step 5, in the process of the cooling, the standing is performed for natural cooling to avoid human intervention affecting the quality of a finished product.

### Advantageous effects

The present disclosure provides a method for producing pulp softeners using waste cooking oil, which has the following advantageous effects over the prior art.
1. According to the method for producing pulp softeners using waste cooking oil, using the waste cooking oil to produce the pulp softeners through steps 1 to 5 can not only reduce the process and cost of resource utilization of waste cooking oil and improve the utilization value of waste cooking oil, but also reduce the emission of pollutants, which is in line with the concept of environmental protection; and raw materials used in the production process are all renewable resources and are sustainable, and the production process is simple and fast, and suitable for mass production.
2. According to the method for producing pulp softeners using waste cooking oil, in step 1, the filter mesh has the pore diameter of 1 mm; in step 2, the filter mesh is cleaned regularly to avoid clogging, ensuring that the waste cooking oil can fully pass through the filter mesh and the solid matter can be separated thoroughly; and in step 3, in the process of water separation, the time of the separation is controlled between 20 min-30 min, and the temperature of the separation is controlled between 40° C.-60° C. The key technical parameters for each step, such as the pore diameter of the filter mesh, the time of water separation, and the temperature of water separation, are set optimally to ensure a smooth treatment process, and improve the preparation efficiency and quality stability of the product.
3. According to the method for producing pulp softeners using waste cooking oil, in step 5, in the process of adding the caustic soda, the caustic soda is added slowly and evenly with continuous stirring to ensure that the caustic soda is fully dissolved and mixed; in step 5, in the process of the continuous stirring for 2 h-3 h, the stirring intensity is controlled at a moderate level, neither too intense nor too gentle, and the stirring frequency is controlled at a moderate level, neither too fast nor too slow, to ensure that the reactants are fully mixed; and in step 5, in the process of the cooling, the standing is performed for natural cooling to avoid human intervention affecting the quality of the finished product. Controlling the speed of caustic soda addition, stirring intensity and stirring time ensures that the reactants are fully mixed and a reaction is carried out effectively, improving the homogeneity and stability of the product.

### BRIEF DESCRIPTION OF THE DRAWINGS

FIG. 1 is a general flow chart of the present disclosure.

### DETAILED DESCRIPTION

The technical solutions of the examples in the present disclosure will be described clearly and completely by reference to the accompanying drawings of the examples in the present disclosure below. Obviously, the examples described are only some, rather than all examples of the present disclosure. On the basis of the examples of the present disclosure, all the other examples obtained by those ordinary skilled in the art without creative efforts fall within the scope of protection of the present disclosure.

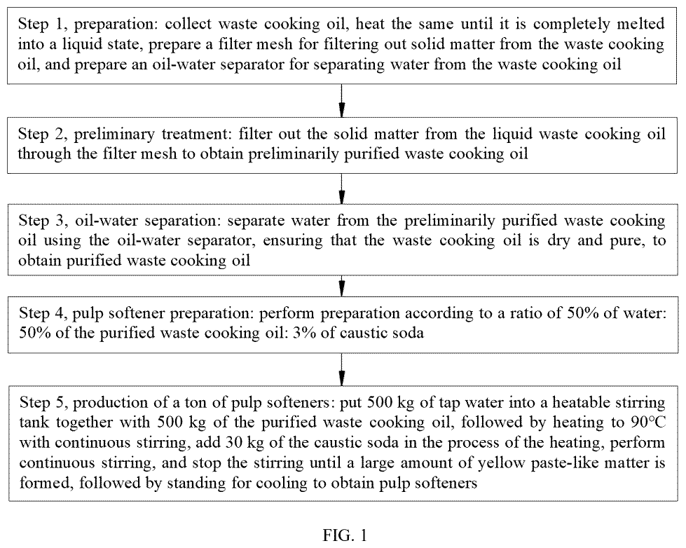

As shown in FIG. 1, the present disclosure provides three technical solutions. A method for producing pulp softeners using waste cooking oil is specifically implemented in the following examples.

Example 1: a method for producing pulp softeners using waste cooking oil includes the following steps.

In step 1, preparation: waste cooking oil was collected, and heated until it was completely melted into a liquid state, a filter mesh was prepared for filtering out solid matter from the waste cooking oil, and an oil-water separator was prepared for separating water from the waste cooking oil.

In step 2, preliminary treatment: the solid matter was filtered out from the liquid waste cooking oil through the filter mesh to obtain preliminarily purified waste cooking oil.

In step 3, oil-water separation: water was separated from the preliminarily purified waste cooking oil using the oil-water separator, ensuring that the waste cooking oil was dry and pure, and purified waste cooking oil was obtained. A separation device of the oil-water separator was cleaned regularly to avoid affecting the effect of oil-water separation, and at the same time, a drainage outlet and a discharge pipeline of the oil-water separator were to be cleaned to ensure that the discharged water was clean and free of impurities. The dryness of the waste cooking oil after oil-water separation was monitored, and if the dryness was not up to standard, the oil-water separation was performed again to ensure that the purified waste cooking oil met the requirements.

In step 4, pulp softener preparation: preparation was performed according to a ratio of 50% of water: 50% of the purified waste cooking oil: 3% caustic soda; and the quality and source of the water had to meet production standards.

In step 5, production of a ton of pulp softeners: 500 kg of tap water were putted into a heatable stirring tank together with 500 kg of the purified waste cooking oil, followed by heating to 90° C. with continuous stirring; 30 kg of the caustic soda were added in the process of the heating, and continuous stirring was performed for 2 h-3 h after the caustic soda was completely added; and the stirring was slowly stopped when yellow paste-like matter was formed on a side of the stirring tank in the process of the continuous stirring, and the stirring was stopped until a large amount of the yellow paste-like matter was formed, followed by standing for cooling to obtain pulp softeners. A pH value and viscosity of the pulp softener were measured to ensure that it met the production requirements. The pH value and viscosity of the pulp softener were adjusted to make the pulp softener reach the optimal state, to improve the production efficiency and product quality. A formula and operating parameters for preparing the pulp softener were recorded, and corresponding management records were established, facilitating the future production and adjustment. Raw material softened water was prepared according to each ton of water being added with 18 kg-30 kg of the caustic soda and 50 kg of the pulp softener, and raw materials for pulp production, such as bamboo chips, wood chips, and bagasse were soaked or stewed in the softened water. After softening, the raw materials were softened, ground and washed to obtain qualified pulp ultimately. About 100 kg of caustic soda could be reduced in the production of one ton of pulp, and using the pulp softener to produce pulp could reduce waste water generation by 70% or more, ultimately lowering the pulp production cost greatly and reducing pollution.

Example 2: the main difference between this example and the first technical solution is as follows. A method for producing pulp softeners using waste cooking oil was provided, in step 1, a filter mesh had a pore diameter of 1 mm; in step 2, the filter mesh was cleaned regularly with clear water or a specific detergent to avoid clogging, ensuring that waste cooking oil can fully pass through the filter mesh and solid matter can be separated thoroughly; in step 3, in the process of water separation, a time of the separation was controlled between 20 min-30 min, and a temperature of the separation was controlled between 40° C.-60° C.; and in step 3, dryness of purified waste cooking oil was verified to ensure that water content in the purified waste cooking oil was between 2%-5%.

Example 3: the main difference between this example and the first technical solution is as follows. A method for producing pulp softeners using waste cooking oil was provided, in step 5, in the process of adding caustic soda, the caustic soda was added slowly and evenly with continuous stirring to ensure that the caustic soda was fully dissolved and mixed; in step 5, in the process of continuous stirring for 2 h-3 h, a stirring intensity was controlled at a moderate level, neither too intense nor too gentle, and a stirring frequency was controlled at a moderate level, neither too fast nor too slow, to ensure that reactants were fully mixed; and in step 5, in the process of cooling, standing was performed for natural cooling to avoid human intervention affecting the quality of a finished product.

It is to be noted that, in the text, the relation terms such as first and second are merely used for distinguishing one entity or operation from another entity or operation, rather than necessarily demanding or implying the existence of any such actual relationship or order between these entities or operations. Moreover, terms “include”, “contain” or any other variations thereof are intended to cover non-exclusive inclusions, so that a process, a method, an object or a device that includes a series of elements may include not only those elements, but also other elements not expressly listed, or also includes elements inherent to the process, the method, the object or the device.

Although the examples of the present disclosure have been shown and described, for those ordinary skilled in the art, it can be understood as various changes, modifications, replacements and variations can be made on these examples within the principle and spirit of the present disclosure. The scope of the present disclosure is defined by the attached claims and the equivalent thereof.

1. A method for producing pulp softeners using waste cooking oil, comprising the following steps:
step 1, preparation: collecting waste cooking oil, heating the same until it is completely melted into a liquid state, preparing a filter mesh for filtering out solid matter from the waste cooking oil, and preparing an oil-water separator for separating water from the waste cooking oil;
step 2, preliminary treatment: filtering out the solid matter from the liquid waste cooking oil through the filter mesh to obtain preliminarily purified waste cooking oil;
step 3, oil-water separation: separating water from the preliminarily purified waste cooking oil using the oil-water separator, ensuring that the waste cooking oil is dry and pure, to obtain purified waste cooking oil;
step 4, pulp softener preparation: performing preparation according to a ratio of 50% of water: 50% of the purified waste cooking oil: 3% of caustic soda; and
step 5, production of a ton of pulp softeners: putting 500 kg of tap water into a heatable stirring tank together with 500 kg of the purified waste cooking oil, followed by heating to 90° C. with continuous stirring, adding 30 kg of the caustic soda in the process of the heating, performing continuous stirring for 2 h-3 h after the caustic soda is completely added, slowly stopping the stirring when yellow paste-like matter is formed on a side of the stirring tank in the process of the continuous stirring, and stopping the stirring until a large amount of the yellow paste-like matter is formed, followed by standing for cooling to obtain pulp softeners.

2. The method for producing pulp softeners using waste cooking oil according to claim 1, wherein in step 1, the filter mesh has a pore diameter of 1 mm.

3. The method for producing pulp softeners using waste cooking oil according to claim 1, wherein in step 2, the filter screen is regularly cleaned to avoid clogging, ensuring that the waste cooking oil is capable of fully passing through the filter mesh and separating the solid matter thoroughly.

4. The method for producing pulp softeners using waste cooking oil according to claim 1, wherein in step 3, in the process of water separation, a time of the separation is controlled between 20 min-30 min, and a temperature of the separation is controlled between 40° C.-60° C.

5. The method for producing pulp softeners using waste cooking oil according to claim 1, wherein in step 3, dryness of the purified waste cooking oil is verified to ensure that water content in the purified waste cooking oil is between 2%-5%.

6. The method for producing pulp softeners using waste cooking oil according to claim 1, wherein in step 5, in the process of adding the caustic soda, the caustic soda is added slowly and evenly with continuous stirring to ensure that the caustic soda is fully dissolved and mixed.

7. The method for producing pulp softeners using waste cooking oil according to claim 1, wherein in step 5, in the process of the continuous stirring for 2 h-3 h, a stirring intensity is controlled at a moderate level, neither too intense nor too gentle, and a stirring frequency is controlled at a moderate level, neither too fast nor too slow, to ensure that reactants are fully mixed.

8. The method for producing pulp softeners using waste cooking oil according to claim 1, wherein in step 5, in the process of the cooling, the standing is performed for natural cooling to avoid human intervention affecting the quality of a finished product.
